(19) United States
(12) Patent Application Publication
(10) Pub. No.: US 2013/0260186 A1
(43) Pub. Date: Oct. 3, 2013

(54) ELECTROCHEMICAL CELL

(71) Applicant: LI-TECH BATTERY GMBH, Kamenz (DE)

(72) Inventor: Tim Schaefer, Harztor (DE)

(73) Assignee: Li-Tech Battery GmbH, Kamenz (DE)

(21) Appl. No.: 13/851,216

(22) Filed: Mar. 27, 2013

Related U.S. Application Data
(60) Provisional application No. 61/615,900, filed on Mar. 27, 2012.

(30) Foreign Application Priority Data
Mar. 27, 2012 (DE) 10 2012 006 200.1

(51) Int. Cl. H01M 10/44

(52) U.S. Cl. CPC H01M 10/44
USPC 429/49

(57) ABSTRACT

A method for modifying an electrochemical cell includes: providing an electrochemical cell including a cathode, an anode, and a layer disposed therebetween, particularly a separator or a polymer electrolyte; effecting at least one charge and discharge sequence on the electro-chemical cell; detecting damage or defect to a first material of a cell component subjected to the at least one first charge and discharge cycle; removing at least portions of the damaged or defective first material from the cell component, whereby at least one cell component is obtained having a first area including the first material and a second area from which damaged or defective first material has been removed;

and introducing a second material into the second area formed in the cell component.

### CROSS-REFERENCE TO RELATED APPLICATIONS

The present application claims the benefit of U.S. Provisional Patent Application Ser. No. 61/615,900, filed Mar, 27, 2012, the entire content of which is hereby incorporated by reference. The present application also claims priority to German Patent Application No. DE 10 2012 006 200.1, filed Mar, 27, 2012, the entire content of which is hereby incorporated by reference.

The present invention relates to an electrochemical cell, wherein the electro-chemical cell comprises at least one cell component particularly selected from among the group consisting of at least one cathode, at least one anode, at least one separator and at least one electrolyte, wherein a first material of the cell component has already been subjected to at least one charge and discharge sequence and is at least partially replaced by a second material after completing the at least one charge and discharge sequence. The cell can preferably be used in batteries for powering vehicles with electric motors preferably in hybrid drives or in “plug-in” operation.

Because of their high energy density and high capacity as energy stores, electrochemical cells, particularly lithium secondary batteries, are used in portable information devices such as e.g. mobile telephones, in tools and in electrically driven automobiles as well as automobiles with hybrid drive. The need for such batteries is continuously rising.

However, manufacturing the electrochemical active material of an electrochemical cell for a lithium ion battery is particularly often coupled with a not insignificant cost, particularly an expenditure of energy and time. Assembling the individual cell components to form an electrochemical cell also requires a number of coordinated process steps.

It is obvious that defects can occur on the way from raw material to operational electrochemical cell which can lead to damaging the entire or also just individual parts or areas of an electrochemical cell, which in turn means that the electrochemical cell cannot be used (any longer).

DE 44 46 675 for example describes a method for repairing manufacturing defects in porous separator webs for accumulators while the separator is being produced.

But an electrochemical cell or just parts or areas of an electrochemical cell can also be damaged during its operation, thereby potentially compromising the functioning of the cell and particularly of the battery.

In both cases, the entire cell would previously have to be discarded, even if only parts or areas of same were defective, which in turn, however, constitutes a not insignificant waste of energy and resources.

The object of the invention is thus based on providing a functional electrochemical cell which can be manufactured economically and at a low energy and material expenditure.

This object is accomplished by the teaching of the independent claims. Preferential further developments of the invention constitute the subject matter of the dependent claims.

In accordance with the invention, a method for modifying an electrochemical cell comprises at least the following steps:
(a) providing an electrochemical cell which comprises at least the following cell components: at least one cathode, at least one anode, and at least one layer disposed between said cathode and anode, particularly a separator or a polymer electrolyte
(b) effecting at least one charge and discharge sequence on the electro-chemical cell from a)
(c) detecting and preferably localizing damage or defect of a first material of at least one cell component subjected to the at least one first charge and discharge cycle pursuant b)
(d) removing at least portions of the damaged or defective first material from the at least one cell component, whereby at least one cell component is obtained consisting of a first area comprising the first material and a second area from which damaged or defective first material has been removed
(e) introducing a second material into the second area formed in the at least one cell component

In one embodiment of the method according to the invention for modifying an electrochemical cell, the first material is substantially materially connected to the second material.

In one embodiment of the method according to the invention for modifying an electrochemical cell, the first material and the second material are selected from an electrode material and/or separator material and/or electrolyte material.

In one embodiment of the method according to the invention for modifying an electrochemical cell, the at least second material is introduced as a fluid or as a replacement substrate in the at least second area of the at least one cell component.

Further an electrochemical cell according to the invention comprises at least one cell component preferably selected from among the group consisting of at least one positive electrode, at least one negative electrode, at least one separator and at least one electrolyte, wherein said cell component comprises at least two areas, wherein one first area substantially comprises a first material and an at least second area substantially comprises at least one second material, wherein the first material of the at least one cell component has already been subjected to at least one charge and discharge sequence and after completing said at least one charge and discharge sequence, is at least partially replaced by a second material.

In one embodiment of the electrochemical cell according to the invention, the at least second material is substantially identical to the first material prior to said first material being subjected to at least one charge- and discharge cycle.

In one embodiment of the electrochemical cell according to the invention, the first material and the at least second material are joined together in a material connection.

A replacement substrate according to the invention comprises at least one material or precursor of the at least one material, wherein the at least one material is capable of at least partially replacing material in an electrochemical cell which has already been subjected to at least one charge and discharge sequence after the completion of said charge and discharge sequence.

The replacement substrate is used according to the invention for replacing at least one area of at least one cell component of an electrochemical cell in particular at least one positive electrode, at least one negative electrode, at least one separator or at least one electrolyte, wherein the electrochemical cell has already been subjected to at least one charge and discharge sequence and after the completion of said charge and discharge sequence, at least one area of the electrochemical cell is replaced by the replacement substrate.

Further according to the invention is the use of the replacement substrate according to the invention for replacing at least one area of at least one cell component of an electrochemical cell, particularly selected from among the group consisting of at least one positive electrode, at least one negative electrode, at least one separator and at least one electrolyte, wherein the electrochemical cell has already been subjected to at least one charge and discharge sequence and after said charge and discharge sequence, at least one area of an electrochemical cell is replaced by a replacement substrate.

Electrochemical Cell

In terms of the present invention, an “electrochemical cell” refers to any type of device for electrically storing energy. The term thus in particular includes electrochemical cells of primary or secondary type but however also other forms of energy stores such as, for example, capacitors. The term “electrochemical cell” also further refers to a corresponding battery, since a battery generally consists of a series or serial connection of individual electrochemical cells. Accordingly, also a respective battery comprising at least one electrochemical cell is always to be understood as an electrochemical cell in the following. Furthermore, the terms battery and accumulator can be also used synonymously.

A lithium ion battery/cell is preferably to be understood as an electrochemical cell. In one preferred embodiment, the electrochemical cell comprises at least one positive electrode, at least one negative electrode and at least one separator separating the positive from the negative electrode, wherein the electrodes and separator are at least partially, and preferably completely, enclosed by at least one casing.

To be understood by “modification” in the terms of the present invention of an electrochemical cell is the manufacturing and/or repair and/or other treatment of an electrochemical cell.

Cell Component

In the sense of the present invention, a “cell component” refers to those elements of an electrochemical cell needed to form a functioning electrochemical cell ready to be connected to a load, thus in particular at least one positive electrode, at least one negative electrode, at least one separator and/or at least one electrolyte or combinations thereof.

Area

In the sense of the present invention, an “area” refers to a three-dimensional body. The expansion of the three-dimensional body in one first dimension can be lesser, greater or equal to the expansion of the three-dimensional body in at least one other dimension.

In one preferred embodiment, the “area” is of layered configuration, wherein the expansion in one dimension is at least 50%, preferably at least 70%, preferably at least 90%, preferably at least 99%, albeit not 100%, less than the expansion in the two other dimensions.

The external form or shape of the three-dimensional body; i.e. its “area” is in principle not limited.

In one embodiment, the external form or shape of the three-dimensional body; i.e. its “area,” corresponds to the form of a regular geometrical body, particularly a sphere or a cylinder or a polyhedron or, particularlypreferred, a cuboid. Further preferable is for the total surface area of the three-dimensional body to be of substantially round, preferably circular or ellipsoidal, or substantially n-angular configuration, wherein n=3−100, preferably n=3, 4, 5, 6, 7, 8, 9, 10, further preferably n=3, 4, 5, 6, and further preferably n=4.

Material

In the sense of the present invention, the term “material” refers to matter (the term “compound” can be synonymously used) typically present or used within an electrochemical cell and which contributes to its functioning. Such matter is in particular electrode material, particularly electrochemical active material, binding agents, conductivity additive(s), furthermore: separator materials, particularly polymer(s), inorganic compound(s), furthermore: electrolyte materials, particularly non-aqueous organic solvent(s), polymer(s), conducting salt(s), ionic liquid(s), electrolyte additive(s). Preferred forms of the electrode, separator and electrolyte material will be defined in greater detail in the subsequent “Electrode,” “Separator” and “Electrolyte” sections and can all be subsumed under the term “material” as defined in the sense of the present invention.

A differentiation can be made between material which has already been subjected to at least one charge and discharge cycle and material not yet having been subjected to any charge and/or discharge cycle. The difference is preferably characterized by chemical (e.g. the material's chemical composition) and/or physical (e.g. particle size or particle size distribution) and/or visual (e.g. gold coloration of graphite containing active material due to formation of LiC₆) parameters.

In one embodiment, the differentiation between a material which has already been subjected to at least one charge and discharge cycle and a material not yet having been subjected to any charge and/or discharge cycle is based on the presence of an SEI layer (SEI=solid electrolyte interface). An SEI layer typically forms on the electrochemical active material during at least one first charge and/or discharge cycle and is thus characteristic of a material which has been subjected to at least one charge and discharge cycle and capable of forming an SEI layer. An SEI layer can be identified for example by electron microscopy on the surface of electrochemical active material, e.g. SEM (scanning electron microscopy).

In one embodiment, the differentiation between a material which has already been subjected to at least one charge and discharge cycle and a material not yet having been subjected to any charge and/or discharge cycle is based on the determined lithium or lithium ion content which, in the case of cathode active material, can be lower after at least one first charge and discharge cycle than the lithium or lithium ion content originally contained in the active material and, in the case of anode active material, can be higher than the lithium or lithium ion content originally contained in the active material. In its present usage, “originally” means at a point in time prior to a first charge and/or discharge cycle.

Replacement Substrate

In the sense of the present invention, the term “replacement substrate” refers to a substrate which comprises at least one material and/or precursor of the at least one material or which consists substantially of same. The replacement substrate preferably comprises cathode material and/or anode material and/or separator material and/or electrolyte material or precursors thereof. Further preferable is for the replacement substrate to comprise material, particularly cathode material and/or anode material and/or separator material and/or electrolyte material which has not yet been subjected to any charge or discharge sequence.

By means of a replacement substrate an at least first material in a first area of at least one cell component having been subjected to at least one charge and discharge sequence is replaced by an at least second material. In one embodiment, the at least second material has not been subjected to any charge and/or discharge sequence up to the point of replacement and is not subjected to a first charge and/or discharge sequence until after the replacement has taken place.

The term “substantially” as used above and in the following means at least 50%, at least 75%, at least 90%, at least up to 99%, preferably 100% in relation to the respective measuring error or usual degree of purity for the respective application.

The following will describe preferred further embodiments of the invention.

A first area of at least one cell component of an electrochemical cell according to the invention preferably at least partially encloses at least one second area of the at least one cell component.

A first area of at least one cell component of an electrochemical cell according to the invention preferably substantially entirely encloses at least one second area of the at least one cell component.

In one embodiment, the first area of at least one cell component of an electrochemical cell according to the invention at least partially encloses a second and third area of the at least one cell component.

In one embodiment, the first area of at least one cell component of an electrochemical cell according to the invention substantially entirely encloses a second and third area of the at least one cell component.

In one embodiment, the first area of at least one cell component of an electrochemical cell according to the invention substantially entirely encloses a second area and partially encloses a third area of the at least one cell component.

According to the invention, the at least second and/or third area of the at least one cell component comprises at least one replacement substrate.

In one preferential embodiment, the at least second and/or third area of the at least one cell component consists substantially entirely of at least one replacement substrate.

In one embodiment, the at least second material is configured as a replacement substrate.

In a further embodiment, a fluid, particularly a liquid, comprises the at least second material.

In one preferred embodiment, the fluid is an electrode suspension or an electrode slurry comprising electrochemical active material and a binding polymer which is preferably homogenously suspended in a suitable solvent, preferably N-methyl pyrrolidone (NMP), and also optionally comprises a conductivity additive.

In the context of the method's application according to the invention, at least one cell component of an electrochemical cell comprises material subsequent at least one first charge and discharge sequence which is no longer able to contribute to the functioning of the electrochemical cell or only able to contribute to a limited extent; i.e. is damaged, in particular defective. Damaged, particularly defective material of a cell component can be differentiated from material which has likewise been subjected to at least one first charge and discharge cycle but which is not damaged, particularly defective, by its considerably lower or complete lack of ability to store and release ions, particularly lithium ions, and/or conduct ions, particularly lithium ions, and/or conduct electrons and/or electrically insulate. According to the invention, the damage or defect and/or the localizing of the damage or defect are first analyzed, preferably identified and/or localized within the electrochemical cell, using a method, preferably a non-destructive testing procedure. Such methods are known to the expert in the prior art. Preferably, methods as described in DE 10 2008 053 009 A and DE 10 2009 018 079 A are used. In one embodiment the analysis, preferably identification and/or localization of the damage or defect is omitted.

Damages or defects to a material of a cell component can occur at a plurality of locations within the cell component. Damages or defects to a material of a cell component can furthermore affect an adjacent cell component and likewise damage or compromise the same.

Damaged, particularly defective material is removed from the at least one cell component. A first area comprising a first material already having been subjected to a first charge and discharge sequence remains in the at least one cell component.

The damaged, particularly defective material is preferably removed in an inert gas atmosphere. This has the advantage of not exposing the remaining functional material to the influence of the atmosphere and thus in particular not coming into contact with water or oxygen. Preserving the functionality of the remaining material can thus be ensured. However, removing damaged, particularly defective material not in an inert gas atmosphere but rather in a “normal” atmosphere is also conceivable. This then becomes advantageous when contact with oxygen or water is not damaging to the remaining functional material

The material removal ensues with methods which are suited to the respective material to be removed, for example using cutting apparatus, e.g. laser cutting or die cutting, or by means of mechanical removal, e.g. using scraping apparatus.

Preferably, the at least one cell component comprising the damaged, particularly defective material to be removed is separated, particularly isolated, from the other cell components prior to said damaged, particularly defective material being removed. This has the advantage of not damaging the other cell components which do not comprise any damaged, particularly defective material, during the removal. Subsequent the separating or isolating of the cell component comprising the damaged, particularly defective, material to be removed, the cell components not comprising any damaged, particularly defective material can be combined with one of the cell components corresponding to “fresh” cell components comprising functioning material, thus assembled back into an operable electrochemical cell.

This has the advantage of being able to obtain directly usable and operable electrochemical cells at low material expenditure and within a short time.

At least one replacement substrate is preferably disposed at that point at which damaged, particularly defective material is removed. Disposing the at least one replacement substrate replaces the damaged, particularly defective material which was removed. This has the advantage of being able to obtain a usable, operable electrochemical cell at low material and energy expenditure. It is however also preferred that a fluid, particularly a liquid comprising the at least second material, to be deposited in those areas from which the damaged, particularly defective material was removed.

In accordance with the invention, the replacement substrate or the fluid at least partially comprises at least one substance, particularly at least one polymer, preferably a binding polymer and/or a separator polymer and/or an electrolyte polymer or precursors thereof which is capable of cross-linking. Said substance is preferably localized at the edge region of the replacement substrate, particularly at the areas of the replacement substrate and the at least first material of the at least first area of at least one cell component which has already been subjected to a charge and discharge cycle but not yet replaced by the replacement substrate. This has the advantage that the replacement substrate being able to be connected, particularly materially connected, to the first material surrounding and contacting the replacement substrate.

Said substance is preferably present in dissolved or homogenously suspended form in the fluid. This has the advantage of thereby ensuring that said material is present particularly in the areas in which the fluid contacts the at least partially surrounding first material of the first area.

The at least one substance, particularly the at least one polymer, preferably comprises reactive groups which are capable of cross-linking upon activation, particularly UV, chemical or thermal activation. The cross linking-capable substance can, however, also be a precursor, particularly a monomer or oligomer.

The cross-linking is effected in order to realize a material connection with the surrounding first material.

The fluid preferably loses continually more of its fluidic properties as substance cross-linking proceeds until the former fluid eventually hardens. Doing so leads to the material connection between the fluid, the now-hardened fluid respectively, and the first material of the first area and the at least second material of the at least second area. It is preferred that a drying step follows, whereby any solvent still present is removed.

The replacement substrate “grows” together with the surrounding first material, particularly at the edge regions of the replacement substrate which are at least partially, preferably substantially entirely, in contact with the first material due to the cross-linking. There is thus a material connection between the replacement substrate and a first material and at least a second area comprising the second material. Thus, the at least second area preferably consists of the replacement substrate in this embodiment.

In one embodiment, the edge region of the replacement substrate is not in contact with the surrounding first material. The material connection between the replacement substrate and first material is not created until after a substance, a polymer in particular, which is capable of cross-linking with the replacement substrate and the first material has been disposed in the area between the first material and the replacement substrate. This substance thus has a first edge region contacting the first material and a second edge region preferably opposite the first edge region contacting the replacement substrate. In this embodiment, the at least second area consists of the replacement substrate and a further substance.

A material connection in terms of the present invention means that the connection can no longer be disengaged nondestructively. The second material can no longer be nondestructively separated from the surrounding first material.

In one embodiment of an electrochemical cell according to the invention, one cell component comprises a first area having electrode material which has been subjected to at least one charge and discharge cycle. In this embodiment, a second area further comprises electrode material which has not yet been subjected to any charge and/or discharge cycle. The substantially material connection of the electrode material of the first area to the electrode material of the second area is in particular made by means of the binding agent contained in the electrode material of the second area which is capable of cross-linking to the electrode material, particularly to the binding agent contained in the electrode material of the first area, upon the electrode material being introduced into the second area.

In a further embodiment of an electrochemical cell according to the invention, one cell component comprises a first area comprising separator material which has been subjected to at least one charge and discharge cycle. In this embodiment, a second area further comprises separator material which has not yet been subjected to any charge and/or discharge cycle. The substantially material connection of the separator material of the first area to the separator material of the second area is in particular made by means of the polymeric compound contained in the separator material of the second area which is capable of cross-linking to the separator material, particularly to the polymeric compound contained in the separator material of the first area, upon the separator material being introduced into the second area.

In a further embodiment of an electrochemical cell according to the invention, one cell component has a first area comprising electrolyte material, particularly polymer electrolyte material, which has been subjected to at least one charge and discharge cycle. In this embodiment, a second area further comprises electrolyte material, particularly polymer electrolyte material, which has not yet been subjected to any charge and/or discharge cycle. The substantially material connection of the polymer electrolyte material of the first area to the polymer electrolyte material of the second area is in particular made by means of the polymeric compound contained in the polymer electrolyte material of the second area which is capable of cross-linking to the polymer electrolyte material, particularly to the polymeric compound contained in the polymer electrolyte material of the first area, upon the polymer electrolyte material being introduced into the second area.

According to the invention, the chemical and/or physical composition of the first material prior to being subjected to a first charge and discharge cycle is substantially identical to the chemical and/or physical composition (thus preferably in terms of the stoichiometry of the compounds obtained, external form of the materials contained (e.g. particles, fibers, layers, films, laminates, etc.) of the quantitative content of different contained compounds or potential sequences of different layers or coatings) of the at least second material of the at least second area or the material of the replacement substrate respectively, preferably corresponds substantially to the chemical and/or physical composition of the at least second material or the material of the replacement substrate respectively. Accordingly, both the first material (prior to being subjected to a first charge and discharge cycle) as well as the at least second material, the material of the replacement substrate respectively, preferably originate from the same batch.

However, it is likewise in accordance with the invention that the chemical and/or physical composition of the first material prior to being subjected to a first charge and discharge cycle to only be partially identical to the chemical and/or physical composition of the at least second material of the at least second area, the material of the replacement substrate respectively. The difference between the material of the first area and the at least second material of the at least second area, the material of the replacement substrate respectively, preferably relates to the substance capable of cross-linking being at least partially, preferably at least 10%, preferably at least 20%, preferably at least 30%, preferably at least 40%, preferably at least 50%, preferably at least 60%, preferably at least 70%, preferably at least 80%, preferably at least 90%, preferably approximately 100% (relative the total percentage of the second material's substance capable of cross-linking) present as a “precursor,” preferably as a monomer and/or oligomer, in the at least second material or the material of the replacement substrate respectively. If the precursor of the cross linking-capable substance is a monomer and/or oligomer, the change in volume during polymerization (polymerization shrinkage) preferably amounts to less than 15 vol %, preferably less than 10 vol %, preferably less than 7 vol %, preferably less than 5 vol %, preferably less than 3 vol % (relative the original volume of the at least second area comprising the at least second material prior to the polymerization or relative the original volume of the replacement substrate respectively).

However, it is likewise in accordance with the invention that, as a component of an electrochemical cell, the at least second material of the at least second area, the material of the replacement substrate respectively, has already been subjected to at least one charge and discharge cycle, thereafter removed from the electrochemical cell and afterwards recycled or reprocessed so as to be reused as “fresh” material in a electrochemical cell. It is thereby particularly preferential for the recycled or reprocessed material to be electrode material, particularly electrochemical active material. It is further preferred that the recycled or reprocessed electrochemical active material to be reused as core-shell material or as a component of a core-shell material in electrochemical cells. Core-shell type materials are composite materials: a first substance or a first substance mixture forms the core and is coated with a second substance or a second substance mixture. Said second substance or second substance mixture thus forms the shell. The core preferably comprises electrochemical active material and the shell is substantially formed from a conductivity additive, particularly carbon. Using recycled or reprocessed electrochemical active material which is in the form of nanoparticles, particularly as the core substance of the core-shell material, is particularlypreferred. However, it is likewise preferable for the recycled or reprocessed material to be separator material or electrolyte material. Using recycled or reprocessed material has the advantage of being able to save on further material and costs.

In one embodiment, the method according to the invention for modifying the electrochemical cell in accordance with the invention comprises the following steps:
providing at least one second material or providing at least one replacement substrate comprised of the at least second material
   and/or
providing an electrochemical cell according to the invention comprising at least one cell component having a first area comprising a first material which has already been subjected to a charge and discharge cycle, and at least one second area having an at least second material with which the first material is at least partially replaced
   and/or
treating the second area comprising the at least second material such that there are substantially no air pockets remaining between the second material and the further cell components disposed above and below same, which is preferably achieved by suctioning out the air pockets and/or by pressing the at least second area comprising the at least second material.

In one embodiment of the method according to the invention for modifying the electrochemical cell, the at least second material is wetted with electrolyte, preferably saturated, preferably with an electrolyte having a higher lithium ion salt concentration than the electrolyte with which the at least first material of the at least first area is saturated. This has the advantage of again increasing the lithium ion concentration in the electrochemical cell as a whole, preferably to a concentration as it was prior to removing the damaged, in particular defective material, since the removal of the damaged, particularly defective material is accompanied by a loss of lithium ions. The wetting, preferably saturation of the at least second material with electrolyte preferably occurs prior to the at least second material being subjected to a first charge and/or discharge step. An additive is thereby preferably additionally used, in particular FEC (FEC=fluoroethylene carbonate) and/or a VC/FEC mixture (VC=vinylene carbonate) and/or an ionic liquid, particularly PYR14TFSI (PYR14TFSI=lithium-bis(fluorosulfonyl)imide).

In one embodiment, the term “charge and/or discharge sequence” is to be understood as a short charge. The at least one charge and/or discharge sequence can furthermore occur prior to or after the electrochemical cell ageing. The charge and/or discharge sequence preferably occurs prior to the main formation.

In one embodiment, the method for modifying an electrochemical cell comprising at least one cell component preferably selected from among the group comprising at least one positive electrode, at least one negative electrode, at least one separator and at least one electrolyte, wherein said cell components comprise at least two areas, wherein a first area substantially comprises a first material and at least a second area substantially comprises an at least second material, is characterized by the first material of the at least one cell component having already been subjected to at least one charge and discharge sequence and partially replaced by a second material after the end of the at least one charge and discharge sequence.

Electrolyte

In one embodiment, the electrochemical cell comprises at least one electrolyte.

A non-aqueous electrolyte containing at least one organic solvent and at least one inorganic or organic salt containing alkali ions, preferably containing lithium ions, can be used as the electrolyte.

In principle, all solvents known to the expert which are used in electrolytes for electrochemical cells can serve as the organic solvent.

The organic solvent is preferably selected from among ethylene carbonate (EC), fluoroethylene carbonate (FEC), preferably mono-fluoroethylene carbonate, propylene carbonate (PC), dimethyl carbonate (DMC), diethyl carbonate (DEC), dipropyl carbonate (DPC), ethyl methyl carbonate (EMC), methyl formate (MF), methyl acrylate (MA), methyl butyrate (MB), ethyl acetate (EA), 1,2-dimethoxyethane, γ-butyrolactone, tetrahydrofurane (THF), 2-methyl tetrahydrofurane, 1,3-dioxylane, sulfolane, ethyl methyl sulfone (EMS), tetramethylene sulfone (TMS), butyl sulfone (BS), ethyl vinyl sulfone (EVS), 1-fluoro-2-(methylsulfonyl)benzene (FS), acetonitrile or phosphoric ester, or mixtures of these solvents.

The alkali ion-containing, preferably lithium ion-containing salt preferably comprises one or more counterions selected from among AsF₆⁻, PF₆⁻, PF₃(C₂F₅)₃⁻, PF₃(CF₃)₃⁻, BF₄⁻, BF₂(CF₃)₂⁻, BF₃(CF₃)⁻, [B(COOCOO)₂]⁻, [B(C₆H₅)₄]⁻, Cl⁻, Br⁻, AlCl₄⁻, CF₃SO₃⁻, C₄F₉SO₃⁻, [(CF₃SO₂)₃C]⁻, [(CF₃SO₂)₂N]⁻, [(C₂F₅SO₂)N]⁻, [(CN)₂N]⁻, ClO₄⁻, SlF₆⁻, or mixtures thereof.

In one embodiment, ionic liquids can also be used as solvents. Such “ionic liquids” only contain ions. Preferred cations, which can in particular be alkylated, are imidazolium, pyridinium, pyrrolidinium, guanidinium, uronium, thiouronium, piperidinium, morpholinium, sulfonium, ammonium and phosphonium cations. Examples of applicable anions are halogenide, tetrafluoroborate, trifluoroacetate, triflate, hexafluorophosphate, phosphinate and tosylate anions.

N-methyl-N-propyl-piperidinium-bis(trifluoromethylsulfonyl)imide, N-methyl-N-butyl-pyrrolidinium-bis(trifluoromethylsulfonyl)imide, N-Butyl-N-trimethyl-ammonium-bis (tri-fluoromethylsulfonyl)imide, triethylsulfonium bis(trifluoromethylsulfonyl)imide, N,N-diethyl-N-methyl-N-(2-methoxyethyl)-ammonium bis(trifluoromethylsulfonyl)-imide are cited as exemplary ionic liquids.

Lithium bis(fluorosulfonyl)imide (PYR14TFSI) is a particularly preferred ionic liquid.

The separator of the electrochemical cell is preferably saturated with the electrolyte.

The electrolyte can furthermore comprise additives as normally used in lithium ion battery electrolytes, for example scavengers such as biphenyl, flame-retardant additives such as organic phosphoric esters or hexamethylphosphoramide, or acid scavengers such as amines.

The electrolyte furthermore preferably comprises additives which can influence the formation of the SEI layer on the electrodes, preferably phenylene carbonate, lithium organoborate either with or without fluorine, for example lithium-difluoro(oxalato)borate (LiDFOB) or lithium-bis(oxalato)borate (LiBOB), and lithium organophosphate either with or without fluorine, for example lithium-tetrafluoro(oxalato)phosphate (LiTFOP) or lithium-tris(oxalato)phosphate (LiTOP).

In one embodiment, the electrolyte is configured as a polymer electrolyte which, apart from the above-noted salts, solvents, additives and additives, comprises a polymer matrix. The polymer or the polymer mixture for the polymer matrix is preferably selected from among the polymers which can be used for separators.

One embodiment uses a polymer electrolyte of a lithium salt and polyethylene oxide.

Electrodes

In accordance with the invention, the term “negative electrode” means that the electrode emits electrons when connected to a load, for example an electric motor. Thus, according to this convention, the negative electrode is the anode.

The negative electrode preferably comprises at least one electrochemical active material which is suited to storing and/or releasing redox components, particularly lithium ions.

In one embodiment, the electrochemical active material of the negative electrode is selected from among the group consisting of amorphous graphite, crystalline graphite, mesocarbon, doped carbon, fullerene, graphene, carbonaceous materials, lithium metal, lithium metal alloys, titanates, silicates, silicon, silicon alloys, tin, tin alloys, niobium pentoxide or mixtures thereof.

In addition to the electrochemical active material, the negative electrode preferably comprises at least one further additive, preferably an additive to increase conductivity, for example a carbon-based additive, e.g. carbon black, and/or a redox active additive which reduces, preferably minimizes, preferably prevents damage to the electrochemical active material upon the electrochemical cell being overcharged.

The negative electrode preferably comprises a metallic substrate. Said metallic substrate is preferably at least partially coated with electrochemical active material.

In one embodiment, the negative electrode comprises a binding agent which is capable of improving the adhesion between electrochemical active material and a metallic substrate. Such a binding agent preferably comprises a polymer, preferably a fluorinated polymer, preferably polyvinylidene fluoride as marketed under the trade names of Kynar® or Dyneon®, polyethylene oxide, polyethylene, polypro-pylene, polytetrafluoroethylene, polyacrylate, ethylene-propylene-diene monomer copolymer (EPDM) and mixtures or copolymers thereof.

The term “positive electrode” means that the electrode absorbs electrons when connected to a load, for example an electric motor. Thus, according to this convention, the positive electrode is the cathode.

The positive electrode of the electrochemical cell preferably comprises at least one electrochemical active material which is suited to storing and/or releasing redox components, particularly lithium ions

In one embodiment, the electrochemical active material of the positive electrode is selected from among at least one oxide, preferably a mixed oxide which comprises one or more elements selected from among nickel, manganese, cobalt, aluminum, phosphorous, iron or titanium.

In one embodiment, the positive electrode comprises a compound having the formula LiMPO₄, wherein M is at least one transition metal cation, preferably a transition metal cation of the first-row transition metals of the periodic table of elements.

The at least one transition metal cation is preferably selected from among the group consisting of manganese, iron, nickel, cobalt or titanium or a combination of these elements. The compound preferably exhibits an olivine structure, preferably superordinate olivine, whereby iron or cobalt are particularly preferential, preferably LiFePO₄ or LiCoPO₄. However, the compound can also have a structure differing from an olivine structure.

In a further embodiment, the positive electrode comprises an oxide, preferably a transition metal oxide, or a transition metal mixed oxide, preferably of spinel type, preferably a lithium manganate, preferably LiMn₂O₄, a lithium cobaltate, preferably LiCoO₂, or a lithium nickelate, preferably LiNiO₂, or a mixture of two or three of these oxides. However, the oxides can also have a structure differing from a spinel type structure.

Additionally to the above-cited transition metal oxides, it is further preferred that the positive electrode comprises, or exclusively comprises a lithium transition metal mixed oxide containing manganese, cobalt and nickel, preferably a lithium cobalt manganate, preferably LiCoMnO₄, preferably a lithium nickel manganese, preferably LiNi_{0.5}Mn_{1.5}O₄, preferably a lithium nickel manganese cobalt oxide, preferably LiNi_{0.33}Mn_{0.33}Co_{0.33}O₂, or a lithium nickel cobalt oxide, preferably LiNiCoO₂, which preferably is or is not of spinel type.

In one embodiment, the positive electrode comprises sulfur or a sulfide, particularly a metal sulfide or a metal polysulfide, preferably a metal selected from among the transition metals which form a sulfide or polysulfide together with sulfur, particularly iron, or selected from among the main group metals which form a sulfide or polysulfide together with sulfur, particularly lithium.

In addition to the electrochemical active material, the positive electrode preferably comprises at least one further additive, preferably an additive to increase conductivity, for example a carbon-based additive, e.g. carbon black, and/or a redox active additive which reduces, preferably minimizes, preferably prevents damage to the electrochemical active material upon the electrochemical cell being overcharged.

The positive electrode preferably comprises a binding agent which is capable of improving the adhesion between electrochemical active material and a metallic substrate. Such a binding agent preferably comprises a polymer, preferably a fluorinated polymer, preferably polyvinylidene fluoride as marketed under the trade names of Kynar® or Dyneon®, polyethylene oxide, polyethylene, polypropylene, polytetrafluoroethylene, polyacrylate, ethylene-propylene-diene monomer copolymer (EPDM) and mixtures or copolymers thereof.

The positive electrode preferably comprises a metallic substrate. Said metallic substrate is preferably at least partially coated with electrochemical active material.

As defined by the present invention, the term “metallic substrate” preferably relates to that component of an electrochemical cell known as the “electrode support” and “collector.” The metallic substrate is predominantly suited for the depositing of electrochemical active mass and is substantially of metallic nature, preferably completely metallic.

At least one electrode preferably at least partially comprises a metallic substrate. Said metallic substrate is preferably formed at least partially as a film or reticulation or webbing, preferably comprising a metal.

In one embodiment, a metallic substrate comprises copper or an alloy containing copper. In a further embodiment, a metallic substrate comprises aluminum. In one embodiment, the metallic substrate can be formed as a film, reticulation or webbing which preferably at least partially comprises at least one plastic.

Preferably, up to 30%, preferably up to 50%, preferably up to 70%, preferably up to 100% of the total surface area of a metallic substrate comprises at least one layer comprising at least one electrochemical active material which is suited to store and/or release lithium ions.

Separator

One embodiment uses a separator for separating the positive electrode from the negative electrode which does not or only poorly conducts electrons and which consists of a substrate at least partially permeable to material. The substrate is preferably coated on at least one side with an inorganic material. An organic material which is preferably formed as nonwoven material is preferably used as the at least partially material-permeable substrate.

The organic material, which preferably comprises a polymer and particularly preferentially one or more polymers selected from among polyethylene terephthalate (PET), polyolefin or polyetherimide, is coated with an inorganic, preferably ion-conducting material which is preferably conductive to ions in a temperature range of from −40° C. to 200° C. and which preferentially comprises at least one compound selected from among the group of oxides, phosphates, silicates, titanates, sulfates, aluminosilicates having at least one of the elements of zircon, aluminum, lithium and particularly preferentially zirconium oxide.

It is preferential for the inorganic, ion-conducting material of the separator to exhibit particles having a diameter of less than 100 μm, preferably less than 10 μm, preferably from 0.5 to 7 μm, preferably from 1 to 5 μm, preferably 1.5 to 3 μm.

In one embodiment, the separator exhibits a porous inorganic coating on and in the nonwoven material comprising aluminum oxide particles having an average particle size of from 0.5 to 7 μm, preferentially from 1 to 5 μm and particularly preferentially from 1.5 to 3 μm which are bonded with an oxide of the Zr or Si elements.

In order to obtain the highest porosity possible, more than 50 wt % and particularly preferentially more than 80 wt % of all the particles are in the above-cited average particle size range. The maximum particle size preferably amounts to ⅓ to ⅕ and particularly preferably to less than or equal to 1/10 of the thickness of the nonwoven material employed.

Suitable polyolefins are preferably polyethylene, polypropylene or polymethylpentene. Polypropylene is particularly preferential. Using polyamides, polyacrylonitriles, polycarbonates, polysulfones, polyethersulfones, polyvinylidene fluorides or polystyrenes as organic substrate material is likewise conceivable. Mixtures of the polymers can also be used.

A separator having PET as the substrate material is commercially available by the name of Separion®. It can be manufactured according to the methods as disclosed in EP 1 017 476.

The term “nonwoven material” means that the polymer is in the form of fibers which are not woven (non-woven fabric). This type of nonwoven fabric is known from the prior art and/or can be produced in accordance with known methods, for example in a spun-bonding or melt-blowing process as discussed e.g. in DE 195 01 271 A1.

The separator preferably comprises a nonwoven fabric having an average thickness of 5 to 30 μm, preferably 10 to 20 μm. The nonwoven fabric is preferably of flexible design. The nonwoven fabric preferably has a homogenous pore radius distribution, preferably at least 50% of the pores have a pore radius of 75 to 100 μm. The nonwoven fabric preferably has a porosity of 50%, preferably 50 to 97%.

“Porosity” is defined as the volume of the nonwoven fabric (100%) minus the volume of the fibers of the nonwoven fabric (corresponds to the percentage of the volume of the nonwoven fabric not filled by material). The volume of the nonwoven fabric can thereby be calculated from its dimensions. The volume of the fibers yields from the measured weight of the respective nonwoven fabric and the density of the polymer fibers. The high porosity of the nonwoven fabric also enables the separator to have a higher porosity, whereby the separator can realize a greater absorption of electrolytes.

In a further embodiment, the separator consists of a polyethylene glycol terephthalate, a polyolefin, a polyetherimide, a polyamide, a polyacrylonitrile, a polycarbonate, a polysulfone, a polyethersulfone, a polyvinylidene fluoride, a polystyrene or mixtures thereof. The separator preferably consists of a polyolefin or a mixture of polyolefins. Particularly preferential in this embodiment is then a separator consisting of a mixture of polyethylene and polypropylene.

Such separators preferably have a layer thickness of from 3 to 14 μm.

The polymers are preferably in the form of a fibrous web, wherein the polymer fibers preferably have an average diameter of from 0.1 to 10 μm, preferably 1 to 4 μm.

As defined by the present invention, the term “mixture” of polymers means that the polymers preferably take the form of their nonwoven fabrics connected to each other in layers. Such nonwovens and/or nonwoven laminates are disclosed for example in EP 1 852 926.

In a further embodiment of the separator, same consists of an inorganic material. Oxides of magnesium, calcium, aluminum, silicon and titanium are preferably used as the inorganic material as well as silicates and zeolites, borates and phosphates. Such materials for separators as well as methods for producing the separators are disclosed in EP 1 783 852. In one preferred embodiment of this embodiment of a separator, the separator consists of magnesium oxide.

In accordance with a further embodiment, the at least one separator which does not or only poorly conducts electrons, but which is conductive to ions, consists at least predominantly or wholly of a ceramic, preferably an oxide ceramic. This embodiment has the advantage of improving the stability of the electrode assembly at temperatures above 100° C.

In a further embodiment of the separator, 50-80 wt % of the magnesium oxide can be replaced by calcium oxide, barium oxide, barium carbonate or lithium, sodium, potassium, magnesium, calcium, barium phosphate or by lithium, sodium or potassium borate or mixtures of these compounds.

The separators of this embodiment preferably have a layer thickness of from 4 to 25 μm.

The electrochemical cell according to the invention preferably has a capacity of at least 3 ampere-hours [Ah], further preferentially of at least 5 Ah, further preferentially of at least 10 Ah, further preferentially of at least 20 Ah, further preferentially of at least 50 Ah, further preferentially of at least 100 Ah, further preferentially of at least 200 Ah, further preferentially of at most 500 Ah. This design provides the advantage of increasing the service life of the load which the electrochemical cell supplies.

The electrochemical cell according to the invention is preferably configured so as to at least intermittently, preferably for over at least one hour, have an electrical current of at least 50 A, further preferentially of at least 100 A, further preferentially of at least 200 A, further preferentially of at least 500 A, further preferentially of at most 1000 A. This design provides the advantage of improving the performance of the load which the electrochemical cell supplies.

The electrochemical cell according to the invention is preferably designed to have a ready voltage, a terminal voltage in particular, at least intermittently, preferably for over at least one hour, of at least 1.2 V, further preferentially of at least 1.5 V, further preferentially of at least 2 V, further preferentially of at least 2.5 V, further preferentially of at least 3 V, further preferentially of at least 3.5 V, further preferentially of at least 4 V, further preferentially of at least 4.5 V, further preferentially of at least 5 V, further preferentially of at least 5.5 V, further preferentially of at least 6 V, further preferentially of at least 6.5 V, further preferentially of at least 7 V, further preferentially of at most 7.5 V. The secondary cell preferably comprises lithium ions. This design provides the advantage of increasing the electrochemical cell's energy density.

The electrochemical cell according to the invention is preferably at least intermittently, preferably for over at least one hour, operable within a temperature range of between −40° C. and 100° C., further preferentially of between −20° C. and 80° C., further preferentially of between −10° C. and 60° C., further preferentially of between 0° C. and 40°. This design provides the advantage of the most unlimited possible positioning or use respectively of the electrochemical cell to supply a load, particularly a motor vehicle or a stationary system and/or mechanism.

The electrochemical cell preferably has a gravimetric energy density of at least 50 Wh/kg, further preferentially of at least 100 Wh/kg, further preferentially of at least 200 Wh/kg, further preferentially of less than 500 Wh/kg. The electrode assembly preferably comprises lithium ions. This design provides the advantage of increasing the electrochemical cell's energy density.

In accordance with a preferred embodiment, the electrochemical cell is provided for installation into a vehicle having at least one electric motor. The electrochemical cell is preferably provided to supply said electric motor. The electrochemical cell is provided particularly preferentially to at least intermittently supply an electric motor for a drive train of a hybrid or electric vehicle. This design provides the advantage of improving the supply to the electric motor.

In accordance with a further preferred embodiment, the electrochemical cell is provided for use in a stationary battery, particularly a buffer memory, as a device battery, an industrial battery or a starter battery. The nominal charge capacity of the electrochemical cell for these applications preferably amounts to at least 3 Ah, particularly preferentially at least 10 Ah. This design provides the advantage of improving the supplying of a stationary load, particularly a stationary mounted electric motor.

Further advantages, features and possible applications of the present invention will ensue from the following description in conjunction with the figures.

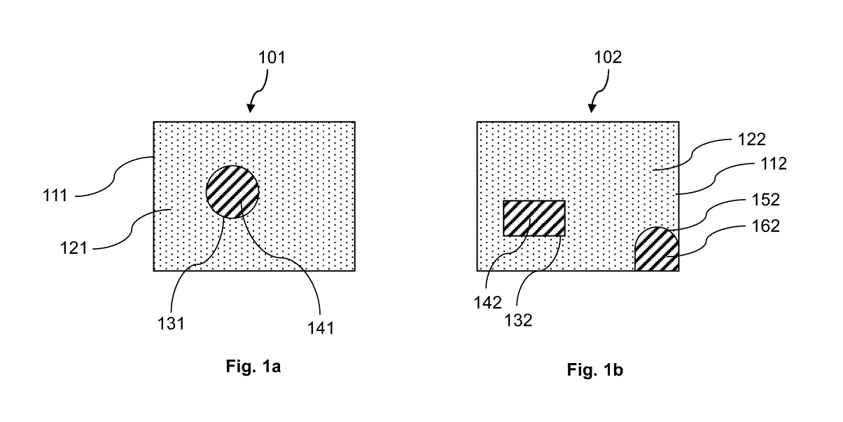

FIG. 1a shows a schematic view of the configuration of one embodiment of a cell component of an electrochemical cell according to the invention,

FIG. 1b shows a schematic view of the configuration of a further embodiment of a cell component of an electrochemical cell according to the invention,

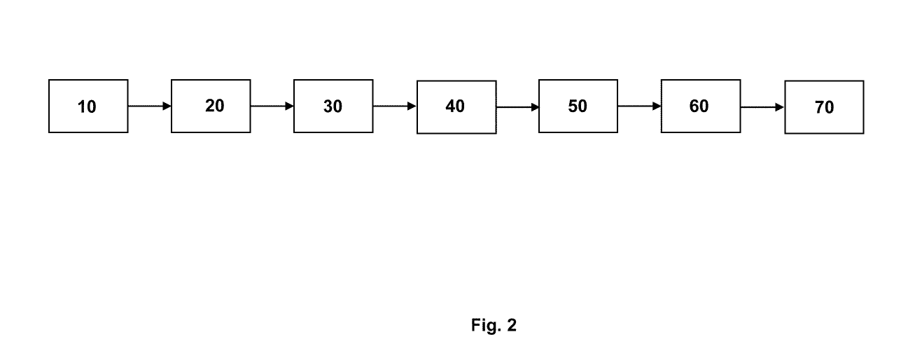

FIG. 2 shows a schematic view of an embodiment of the method according to the invention of manufacturing an electrochemical cell in accordance with the invention,

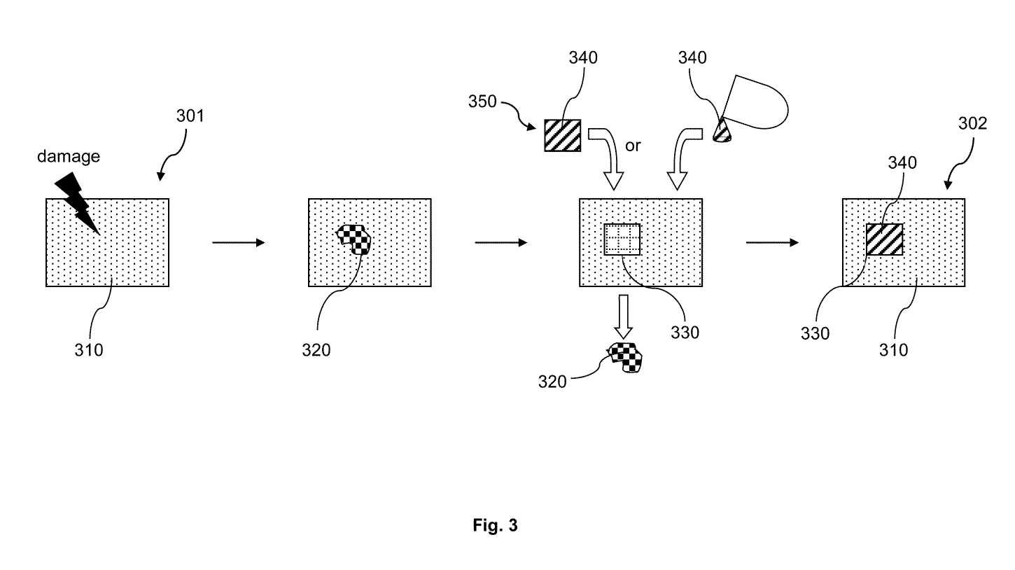

FIG. 3 shows a schematic view of an embodiment of selected steps in the method according to the invention of manufacturing an electrochemical cell in accordance with the invention,

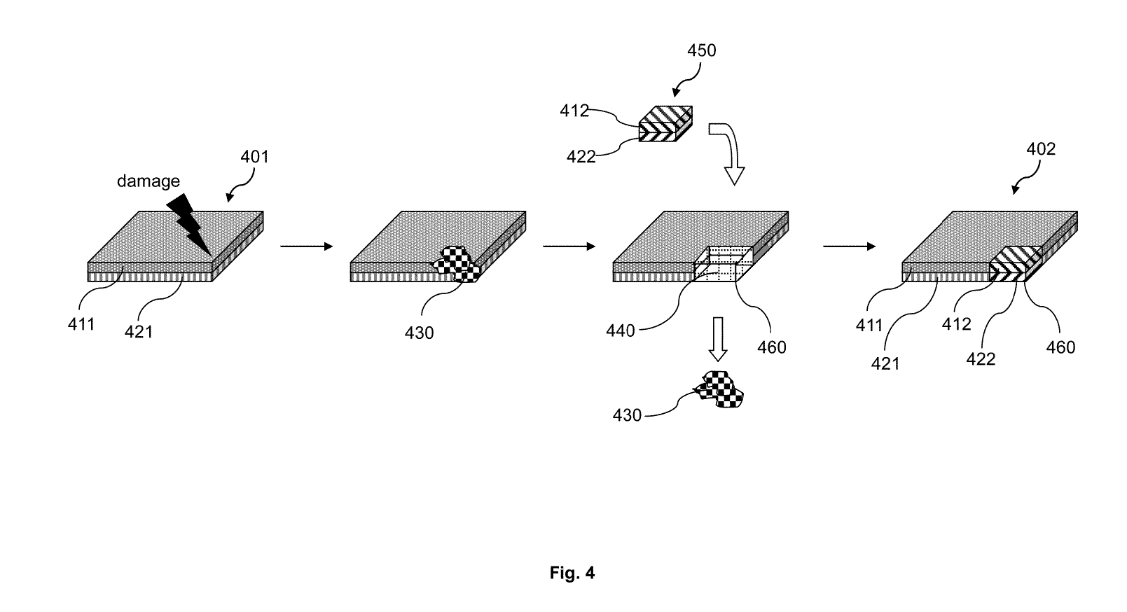

FIG. 4 shows a schematic view of a further embodiment of selected steps in the method according to the invention of manufacturing an electrochemical cell in accordance with the invention.

FIG. 1a shows a schematic view of the configuration of a cell component 101 for an electrochemical cell according to the invention consisting of a first area 111 comprising a first material 121 and a second area 131 comprising a second material 141, wherein the first material 121 of the first area 111 has already been subjected to at least one charge and discharge sequence, and after completing the at least one charge and discharge sequence, is replaced within the second area 131 by the second material 141 of second area 141. The first area 111 comprising the first material 121 completely encloses the second area 131 comprising the second material 141 in this embodiment. The first material 121 and the second material 141 are substantially fully materially connected to one another in the edge region.

FIG. 1b shows a schematic view of the configuration of a cell component 102 for an electrochemical cell according to the invention consisting of a first area 112 comprising a first material 122, a second area 132 comprising a second material 142 and a third area 152 comprising a third material 162. The second material 142 and the third material 162 are preferably identical. The first material 122 of the first area 112 has already been subjected to at least one first charge and discharge sequence and, after completing the at least one charge and discharge sequence, is replaced by the second material 142 of the second area 132 and by the third material 162 of the third area 152. The first area 112 comprising the first material 122 completely encloses the second area 132 comprising the second material 142 and partially encloses the third area 152 comprising the third material 162. The first material 122 is substantially fully materially connected to the second material 142 and the third material 162 in the edge region.

FIG. 2 schematically shows an embodiment of the method according to the invention of manufacturing an electrochemical cell according to the invention, which comprises the following steps:
providing an electrochemical cell comprising at least one cell component, preferably selected from among the group comprising at least one cathode, at least one anode and at least one layer arranged between the cathode and anode, in particular a separator or a polymer electrolyte (10)
operating the electrochemical cell, in particular by running at least one charge and discharge sequence (20)
providing at least one second material (30)
detecting and localizing damage to and/or a defect in a first material of at least one cell component of the electrochemical cell which has already been subjected to at least one first charge/discharge cycle (40)
removing the damaged or defective first material of the at least one cell component, whereby at least one cell component is obtained comprising a first area comprising the first material and a second area from which the damaged or defective first material was removed (50)
introducing the second material provided in step 30 into the second area produced and substantially materially connecting the first material to the second material (60)
finalizing an electrochemical cell according to the invention comprising at least one cell component having a first area comprising a first material which has already been subjected to at least one charge and discharge cycle and at least one second area having an at least second material with which the first material is at least partially replaced (70)

Each of steps 10, 20, 40 and 70 are optional and can be performed independently of one another in the above illustrated order or in a different order.

Steps 30, 50 and 60 are according to the invention. In one embodiment, the second material provided in step 30 is in the form of a replacement substrate and in a further embodiment, in fluid or fluid-like form, particularly as liquid.

Steps 30-70 as specified in FIG. 2 are visually depicted and detailed schematically in FIGS. 3 and 4.

FIG. 3 shows a schematic view of an embodiment of the method according to the invention of manufacturing an electrochemical cell in accordance with the invention. In a first step pertaining to a cell component 301 comprising a first area comprising a first material 310 which has already been subjected to at least one first charge and discharge sequence, the first material experiences damage. The damage causes an area to form within the first area comprising the first material which exhibits damaged or defective first material 320. This area is identified by suitable procedures and the damaged or defective first material 320 is removed from the first area comprising the first material 310 in a further step, whereby a second area 330 is formed.

In one embodiment of the example, a replacement substrate 350 comprising a second material 340 is provided. The replacement substrate 350 comprising the second material 340 is fit into the second area 330 in a further step. A material connection between the replacement substrate 350 comprising the second material 340 and the first material 310 of the first area is induced in a further step and a cell component 302 is produced consisting of a first area comprising a first material 310 already having been subjected to at least one charge and discharge sequence and a second area 330 comprising the second material 340.

A fluid comprising the second material 340 is provided in a further embodiment of the example. The fluid comprising the second material 340 is introduced into the second area 330, preferably cast into same. In a further step, a material connection is made between the fluid comprising the second material 340 and the first material 310 of the first area, with the fluid preferably hardening thereby, producing a cell component 302 consisting of a first area comprising a first material 310 already having been subjected to at least one charge and discharge sequence and a second area 330 comprising the second material 340.

FIG. 4 shows a schematic view of a further embodiment of the method according to the invention of manufacturing an electrochemical cell 401 in accordance with the invention. In a first step, a first cell component comprising a first area and a first material 411 experiences damage which impacts the adjacent second cell component likewise comprising a first area comprising a first material 421 which is preferably different from the other first material 411 of the first cell component. The first material 411 of the first cell component and the first material 421 of the second cell component have already been subjected to at least one first charge and discharge sequence and are damaged or defective due to the damage. A second area 460 comprising damaged or defective material of the first and the second cell component 430 is formed which is removed in a further step. A replacement substrate 450 comprising a second material 412 of the first cell component and a second material 422 of the second cell component is provided. The replacement substrate 450 is fit into the second area 460 in a further step. The replacement substrate 450 is thereby disposed such that the second material 412 of the first cell component is at least partially enclosed by the first material 411 of the first cell component and the second material 422 of the second cell component at least partially enclosed by the first material 421 of the second cell component. An electrochemical cell according to the invention 402 thus results with a first cell component having a first area comprising a first material 411 and a second area 460 comprising a second material 412 and a second cell component having a first area comprising a first material 421 and a second area 460 comprising a second material 422.

1-10. (canceled)

11. A method for modifying an electrochemical cell, comprising:
a) providing an electrochemical cell comprising at least one cathode, at least one anode, and at least one layer disposed between cathode and anode, particularly a separator or a polymer electrolyte;
b) effecting at least one charge and discharge sequence on the electro-chemical cell;
c) detecting damage or defect of a first material of at least one cell component subjected to the at least one first charge and discharge cycle;
d) removing at least portions of the damaged or defective first material from the at least one cell component, whereby at least one cell component is obtained comprised of a first area comprising the first material and a second area from which the at least portions of the damaged or defective first material have been removed; and
e) introducing a second material into the second area.

12. The method according to claim 11, further comprising localizing the damage or defect of the first material of the at least one cell component subjected to the at least one first charge and discharge cycle.

13. The method according to claim 11, wherein the first material is substantially materially connected to the second material.

14. The method according to claim 11, wherein the first material and the second material are selected from at least one of (a) an electrode material, (b) a separator material, and (c) an electrolyte material.

15. The method according to claim 11, wherein the at least second material is introduced as a fluid or as a replacement substrate in the at least second area of the at least one cell component.

16. An electrochemical cell comprising:
at least one cell component comprising at least two areas including a first area and a second area, wherein the first area substantially comprises a first material and the second area substantially comprises at least one second material,
wherein the first material of the at least one cell component has been subjected to at least one charge and discharge sequence and has been partially replaced by the second material after completing said at least one charge and discharge sequence.

17. The electrochemical cell according to claim 16, wherein the at least one cell is selected from among the group consisting of: at least one positive electrode, at least one negative electrode, at least one separator, and at least one electrolyte.

18. The electrochemical cell according to claim 16, wherein the at least second material is substantially identical to the first material prior to said first material being subjected to at least one charge and discharge cycle.

19. The electrochemical cell according to claim 16, wherein the first material and the at least second material are joined together in a material connection.

20. A replacement substrate comprising:
at least one material or precursor of the at least one material, wherein the at least one material is capable of at least partially replacing material in an electrochemical cell which has been subjected to at least one charge and discharge sequence after the completion of said charge and discharge sequence.

21. A method comprising:
using a replacement substrate according to claim 20 to replace at least one area of at least one cell component of an electrochemical cell, particularly selected from among the group consisting of: at least one positive electrode, at least one negative electrode, at least one separator, and at least one electrolyte, wherein the electrochemical cell has been subjected to at least one charge and discharge sequence and after said charge and discharge sequence, at least one area of an electrochemical cell is replaced by a replacement substrate.

22. A method comprising:
using an electrochemical cell according to claim 16 to supply energy to at least one of: (a) portable information devices, (b) tools, (c) electrically driven automobiles, (d) automobiles with hybrid drive, and (e) stationary energy stores.
